(19) United States
(12) Patent Application Publication
(10) Pub. No.: US 2025/0137869 A1
(43) Pub. Date: May 1, 2025

(54) FUNCTIONAL SPRINKLER FOR DETECTION OF MICRO-LEAKAGE

(71) Applicant: Paratech Company Limited, Seosan-si (KR)

(72) Inventors: Wook Bin JIN, Bucheon-si (KR); Se Hwan JEON, Bucheon-si (KR); An Bin PARK, Gwangju-si (KR)

(21) Appl. No.: 18/885,889

(22) Filed: Sep. 16, 2024

(30) Foreign Application Priority Data
Oct. 27, 2023 (KR) 10-2023-0145366

(51) Int. Cl. G01M 3/04; A62C 35/68

(52) U.S. Cl. CPC G01M 3/04; A62C 35/68

(57) ABSTRACT

Embodiments relate to a functional sprinkler for detecting microleakage occurring therein, including: a frame; a valve cap; a glass bulb; a deflector; and a layer of a hydrochromic paint applied to a top or underside of the deflector, wherein the layer of the hydrochromic paint changes a color of a portion in which the microleakage occurs.

### CROSS REFERENCE TO RELATED APPLICATION OF THE DISCLOSURE

The present application claims the benefit of Korean Patent Application No. 10-2023-0145366 filed in the Korean Intellectual Property Office on Oct. 27, 2023, the entire contents of which are incorporated herein by reference.

### BACKGROUND OF THE DISCLOSURE

### Field of the Disclosure

The present disclosure relates to a functional sprinkler for detecting microleakage occurring therein, more specifically to a functional sprinkler for detecting microleakage occurring therein, which is built in a building or factory to extinguish a fire, that is capable of allowing leakage symptoms occurring due to wrong construction, defect, or corrosion thereof to be pre-checked with the naked eye of a manager, thereby in advance preventing technological accidents and quality accidents from happening due to the microleakage occurring therein.

### BACKGROUND OF THE RELATED ART

Generally, a sprinkler system is installed inside a building or factory to initially extinguish a fire when the fire occurs. In the case of factory facilities, recently, fast market changes have occurred, so that leakage occurring due to changed building designs or aged sprinklers may cause frequent technological accidents and quality accidents, and especially in the case of a semiconductor factory, equipment malfunctions and contamination of produced wafers may be made due to leakages occurring in sprinklers installed in the factory, thereby causing a loss of several hundreds of thousands of dollars annually.

To pre-check whether leakage exists, a company for installing and managing sprinklers in a building or factory performs the maintenance and checking works of the sprinklers through the input of tens of workers, and moreover, a period of time required for such works may be maximum three months, so that enormous time and cost may be required.

Further, most of sprinklers are installed on a ceiling of the building or factory, and therefore, they have to be checked one by one through a bubble check or leak tester in an aerial area (which may need a risky work), thereby causing workers that perform such checks to be always exposed to safety accidents.

### SUMMARY OF THE DISCLOSURE

Accordingly, the present disclosure has been made in view of the above-mentioned problems occurring in the related art, and it is an object of the present disclosure to provide a functional sprinkler for detecting microleakage occurring therein that is capable of allowing a hydrochromic paint to be coated onto an end portion (deflector) thereof in such a way as to be changed in color if the microleakage occurs therein, so that a portion where the microleakage occurs can be checked with the naked eye of a manager, without having any need to perform aerial work for checking leakage symptoms occurring due to wrong construction, defect, or corrosion of the sprinkler through the input of tens of workers.

It is another object of the present disclosure to provide a functional sprinkler for detecting microleakage and a method for detecting microleakage in the corresponding sprinkler that are capable of minimizing occurrence of safety accidents and technological accidents.

To accomplish the above-mentioned objects, according to one aspect of the present disclosure, there is provided a functional sprinkler for detecting microleakage occurring therein, including: a frame; a valve cap; a glass bulb; a deflector; and a layer of a hydrochromic paint applied to a top or underside of the deflector, wherein the layer of the hydrochromic paint changes a color of a portion in which the microleakage occurs.

According to the present disclosure, desirably, the layer of a hydrochromic paint may be formed to a thickness in the range between 10 and 50 μm by using any one selected from wet coating, dry coating, and spray coating.

According to the present disclosure, desirably, the hydrochromic paint may include: 3 to 10% by weight of a dye; 5 to 10% by weight of a pigment; 10 to 25% by weight of synthetic resins; and a residual amount of solvents, based on 100% by weight thereof.

According to the present disclosure, desirably, the hydrochromic paint may contain 30 to 50% by weight of solid content, based on 100% by weight thereof.

According to the present disclosure, desirably, the hydrochromic paint may have a pH range between 4 to 7.

According to the present disclosure, desirably, the dye may be a pH indicator or redox indicator and be any one selected from bromophenol blue (BPB), bromocresol green (BCG), indigo carmine (IC), and cresol red (CR).

According to the present disclosure, desirably, the pigment may be an inorganic pigment and be any one selected from titanium dioxide, silicon dioxide, calcium carbonate, calcium oxide, calcium hydroxide, zeolite, activated carbon, bentonite, and aluminum silicate.

According to the present disclosure, desirably, the synthetic resins may be one or more materials selected from the group consisting of alkyd, acrylic polymer, polyester, phenol, melamine, urethane, silicone, and ester.

According to the present disclosure, desirably, the additives may be one or more materials selected from a curing accelerator, an adhesion promotor, a dispersant, and a mixture thereof.

According to the present disclosure, desirably, the solvents may be one or more materials selected from water, alcohol, ester, ketone, ether, and a mixture thereof.

To accomplish the above-mentioned objects, according to another aspect of the present disclosure, there is provided a method for detecting microleakage in a sprinkler having a frame, a valve cap, a glass bulb, and a deflector, the method comprising the steps of: coating a hydrochromic paint onto a top or underside of the deflector; and if the microleakage occurs on a portion of the deflector where the hydrochromic paint is coated, detecting the microleakage through the change of the color of the hydrochromic paint coated onto the portion of the deflector where the microleakage occurs, wherein the hydrochromic paint comprises a dye, a pigment, synthetic resins, additives, and solvents.

According to the present disclosure, desirably, the method may further include the step of drying the hydrochromic paint through a heat treatment at a temperature between 12° and 180° C. for 10 to 30 minutes after the hydrochromic paint has been coated onto the top or underside of the deflector.

According to the present disclosure, desirably, the hydrochromic paint may be coated a plurality of times.

### BRIEF DESCRIPTION OF THE DRAWINGS

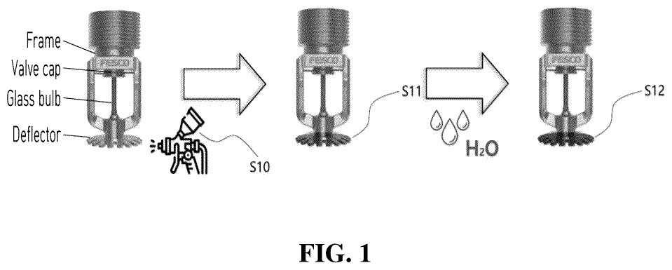

The above and other objects, features and advantages of the present disclosure will be apparent from the following detailed description of the preferred embodiments of the disclosure in conjunction with the accompanying drawings, in which FIG. 1 is a flowchart showing mixing order of materials when a hydrochromic paint is made according to an embodiment of the present disclosure.

### DETAILED DESCRIPTION OF THE PREFERRED EMBODIMENTS

Hereinafter, embodiments of the present disclosure will be explained in detail with reference to the attached drawings. Before the present disclosure is disclosed and described, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one of ordinary skill in the art to variously employ the present disclosure in virtually any appropriately detailed structure.

Terms used in this application are used to only describe specific exemplary embodiments and are not intended to restrict the present disclosure. An expression referencing a singular value additionally refers to a corresponding expression of the plural number, unless explicitly limited otherwise by the context. In the description, when it is said that one portion is described as “includes” any component, one element further may include other components unless no specific description is suggested.

When it is said that one element is described as being “connected” or “coupled” to the other element, one element may be directly connected or coupled to the other element, but it should be understood that another element may be present between the two elements. In contrast, when it is said that one element is described as being “directly connected” or “directly coupled” to the other element, it should be understood that another element is not present between the two elements.

According to an embodiment of the present disclosure, there is provided a functional sprinkler for detecting microleakage occurring therein, the functional sprinkler including: a frame; a valve cap; a glass bulb; a deflector; and a layer of a hydrochromic paint applied to a top or underside of the deflector, wherein the layer of the hydrochromic paint changes a color of a portion in which the microleakage occurs.

Now, an explanation of the functional sprinkler for detecting microleakage occurring therein according to the embodiment of the present disclosure will be given in detail.

FIG. 1 is a flowchart showing mixing order of materials constituting a hydrochromic paint when the hydrochromic paint is made according to an embodiment of the present disclosure. First, a dye and solvents are mixed to make a dye solution, and next, a pigment is added to the dye solution to make a mixed dispersion liquid. After that, synthetic resins are added to the mixed dispersion liquid through primary high-pressure dispersion to make a mixed coating liquid. Next, the mixed coating liquid is subjected to secondary high-pressure dispersion to make the hydrochromic paint.

According to the embodiment of the present disclosure, the layer of the hydrochromic paint is formed to a thickness in the range between 10 and 50 μm by using any one selected from wet coating, dry coating, and spray coating. If the range is over, the layer of the hydrochromic paint is too thick or thin to obtain a good microleakage detection efficiency. If the thickness is greater than 50 μm, water reaction time greater than or equal to 30 minutes is needed, thereby lowering the microleakage detection efficiency.

According to the embodiment of the present disclosure, the hydrochromic paint includes: 3 to 10% by weight of a dye; 5 to 10% by weight of a pigment; 10 to 25% by weight of synthetic resins; and a residual amount of solvents, based on 100% by weight thereof. Further, the hydrochromic paint includes 2 to 5% by weight of additives, based on 100% by weight thereof. Desirably, the hydrochromic paint includes 4.0 to 5.0% by weight of a dye; 7.0 to 8.0% by weight of a pigment; 20 to 25% by weight of synthetic resins; 3 to 5% by weight of additives; and a residual amount (about 60 to 70% by weight) of solvents, based on 100% by weight thereof.

According to the embodiment of the present disclosure, the hydrochromic paint contains 30 to 50% by weight of solid content, based on 100% by weight thereof.

According to the embodiment of the present disclosure, the deflector as an object to be coated with the hydrochromic paint is classified into non-plated, STS plated, and brass deflectors, and the deflector is subjected to a primer treatment to strengthen adhesion of the hydrochromic paint thereto.

According to the embodiment of the present disclosure, after coated, the hydrochromic paint is dried through a heat treatment at a temperature between 12° and 180° C. for 10 to 30 minutes.

If water is detected from a portion where the hydrochromic paint is coated, the color of the portion changes. Referring to FIG. 1, the sprinkler, which has a deflector adapted to produce a spray pattern, while the deflector being coated with the hydrochromic paint in a step S10, is installed on a building or factory, and if the sprinkler is not properly installed or has its own defect, water (H₂O) is collected in a direction of gravity, so that the water gathers toward the deflector coated with the hydrochromic paint in a step S11. The hydrochromic paint has a chemical reaction (wherein water induces an oxygen reaction of the dye of the hydrochromic paint) with the water to cause the deflector to be changed in color in a step S12.

Even in the case where microleakage occurs due to aging or corrosion of the normal sprinkler after the use of a long period of time of the sprinkler, further, the hydrochromic paint has a chemical reaction with the water to cause the deflector to be changed in color in the step S12, so that an exact replacement time of the sprinkler can be checked with the naked eye of a sprinkler manager.

In the process of coating the hydrochromic paint, a method for using additional solvents may be used to enhance reversibility and dryness of the hydrochromic paint.

According to the embodiment of the present disclosure, the hydrochromic paint contains 30 to 50% by weight of solid content, based on 100% by weight thereof.

According to the embodiment of the present disclosure, the hydrochromic paint has a pH range between 4 to 7. If the hydrochromic paint is not in the above range, the solid content of the hydrochromic paint is not present in an optimal amount, thereby undesirably making leakage detection performance deteriorated.

According to the embodiment of the present disclosure, the dye is a pH indicator or redox indicator, and the pH indicator is any one selected from bromophenol blue (BPB), bromocresol green (BCG), indigo carmine (IC), and cresol red (CR), preferably indigo carmine (IC). According to the embodiment of the present disclosure, the pigment is an inorganic pigment and any one selected from titanium dioxide, silicon dioxide, calcium carbonate, calcium oxide, calcium hydroxide, zeolite, activated carbon, bentonite, and aluminum silicate.

According to the embodiment of the present disclosure, the synthetic resins are one or more materials selected from the group consisting of alkyd, acrylic polymer, polyester, phenol, melamine, urethane, silicone, and ester, preferably acrylic polymer.

According to the embodiment of the present disclosure, the additives are one or more materials selected from a curing accelerator, an adhesion promotor, a dispersant, and a mixture thereof, preferably a dispersant.

According to the embodiment of the present disclosure, the solvents are one or more materials selected from water, alcohol, ester, ketone, ether, and a mixture thereof, preferably ethanol, isopropyl alcohol, and water.

According to another embodiment of the present disclosure, there is provided a method for detecting microleakage in a sprinkler having a frame, a valve cap, a glass bulb, and a deflector, the method including the steps of: coating a hydrochromic paint onto a top or underside of the deflector; and if the microleakage occurs on a portion of the deflector where the hydrochromic paint is coated, detecting the microleakage through the change of the color of the hydrochromic paint coated onto the portion of the deflector where the microleakage occurs, wherein the hydrochromic paint includes a dye, a pigment, synthetic resins, additives, and solvents.

Now, the method for detecting microleakage in the sprinkler according to another embodiment of the present disclosure will be explained in detail.

According to the embodiment of the present disclosure, the method further comprises the step of drying the hydrochromic paint through a heat treatment at a temperature between 12° and 180° C. for 10 to 30 minutes after the hydrochromic paint has been coated onto the top or underside of the deflector.

According to the embodiment of the present disclosure, the hydrochromic paint is coated a plurality of times.

Hereinafter, an explanation of the embodiments of the present disclosure will be given in detail so that the embodiments are carried out easily by a person skilled in the art. However, it is to be understood that the disclosed embodiments are merely exemplary of the disclosure, which can be embodied in various forms.

### Embodiments 1 to 4: Hydrochromic Paint Making

A hydrochromic paint was made to detect microleakage in a sprinkler

### Dispersion Liquid Making

The materials, which constitute the hydrochromic paint, were added in respective amounts and mixed at 6,000 rpm for 5 minutes by using a Homo mixer, thereby making a dispersion liquid.

### Coating Liquid Making

Resins were added in respective amounts to the dispersion liquid and then mixed at 6,000 rpm for 15 minutes by using the Homo mixer, thereby making a coating liquid.

### Bubble Removal

A bubble removal process was performed to remove the bubbles remaining in the coating liquid. The bubble removal process was carried out by mixing the coating liquid at 2,000 rpm for 5 minutes by using the Homo mixer.

Table 1 as suggested below show the amounts of the respective materials constituting the hydrochromic paints according to the first to fourth embodiments of the present disclosure.

TABLE 1

| | | Embodiments | | | |
|---|---|---|---|---|---|
| Materials | | #1 | #2 | #3 | #4 |
| Dye | Indigo carmine | 4.5% | 4.5% | 2.5% | 4.5% |
| Pigment | Titanium dioxide | 7.5% | 7.5% | 7.5% | 10.0% |
| Solvent | Ethanol | 55.0% | 40% | 57.0% | 52.5% |
| | Isopropyl alcohol | 1.0% | 1.0% | 1.0% | 1.0% |
| | Water | 9.0% | 9.0% | 9.0% | 9.0% |
| Resin | Acrylic polymer | 23.0% | 38.0% | 23.0% | 23.0% |

### Embodiment 2: Sprinkler Deflector Coated with Hydrochromic Paint

The hydrochromic paints made according to the first to fourth embodiments of the present disclosure were applied to the undersides or tops of the corresponding deflectors by means of spray coating so that they have a thicknesses of 30 μm, and next, they were subjected to thermal drying at a temperature of 150° C. for 10 minutes or more, thereby being cured and dried.

### Experimental Example 1: Performance Evaluation Upon Leakage of the Sprinkler Coated with Hydrochromic Paint

After the hydrochromic paints made according to the first to fourth embodiments of the present disclosure were applied to the corresponding deflectors, performance upon leakage of sprinklers was evaluated, and here, the evaluated results are suggested in Table 2.

### Experimental Example 2: Reaction Evaluation Upon Change of Dye

Table 3 as will be suggested below shows reaction evaluation results if the dye of the hydrochromic paint is changed.

### Experimental Example 3: Reaction Experiment According to the Number of Coating Times of Hydrochromic Paint

Microleakage reaction was evaluated according to the number of coating times of the hydrochromic paint. Table 4 as will be suggested below shows 1 color coating and 2 color coating conditions and reaction comparison results.

A reaction solution was coated to a thickness of 60 μm on a SUS plate by means of bar coating and then dried with hot air at a temperature of 150° C. for 10 minutes. Reaction evaluation was performed to check whether the coated layer reacts with a droplet of water falling thereon.

### Experimental Example 4: Reaction Evaluation According to Coating Thickness of Hydrochromic Paint

After the hydrochromic paint was made, it was coated onto the underside or top and underside of the sprinkler deflector to a thickness between 10 and 30 μm by means of spray coating, thereby allowing a leakage to be detected in the sprinkler.

Table 5 as will be suggested below shows water reaction time evaluation results according to coating thicknesses of the hydrochromic paint.

TABLE 5

| Coating thickness(μm) | 10 | | 30 | | 50 | |
|---|---|---|---|---|---|---|
| Drying | 150° | C. | 150° | C. | 150° | C. |
| temperature | | | | | | |
| Drying time | 10 | mins | 10 | mins | 30 | mins |
| Water reaction | 10 | secs | 10 | secs | 10 | secs |
| time | | | | | | |

### Experimental Example 5: Adhesion and Hardness Evaluation According to Drying Conditions

After the hydrochromic paint was coated, adhesion and hardness were evaluated according to drying conditions, and the evaluated results are suggested in Table 6.

TABLE 6

| Drying | | | | |
|---|---|---|---|---|
| temperature(° C. ) | 130 | 140 | 150 | 160 |
| Drying time | 10 mins | 10 mins | 10 mins | 10 mins |
| Dried or not | X | X | ◯ | ◯ |
| Adhesion/hardness | 3B/HB | 3B/2H | 5B/4H | 5B/4H |

### Experimental Example 6: Moisture Resistance Experiment of Hydrochromic Paint

The hydrochromic paint according to the first embodiment of the present disclosure was left at an environment of a temperature of 20° C. and humidity of 85% RH for 100 hours, and next, moisture resistance for the hydrochromic paint was evaluated.

Table 7 shows durability and reaction evaluation items of the hydrochromic paint.

TABLE 7

| No. | Division | Detail item | Content | Target value |
|---|---|---|---|---|
| 1 | Durability | Durability | Useful life after coating (Hardness | One year or |
| | | | of coated layer) | more |
| | | | Available temperature | 1 to 99° C. |
| | | | Moisture | 85% RH |

| resistance | | |
|---|---|---|
| Impact test | Not abnormal | |
| Solution storage period | 6 | months |

| | | | | |
|---|---|---|---|---|
| 2 | Reaction | Reaction | Color difference before and after | Color |
| | | Visibility | reaction | difference value |
| | | | | (ΔE > 10) |
| | | Reaction | Time from water falling to color | Within 10 secs |

| | | | |
|---|---|---|---|
| speed | change | | |
| Minimal | Minimal amount of water for color | 0.02 | ml |
| water | change | | |
| amount for | | | |
| detection | | | |

| | | |
|---|---|---|
| Malfunction | Color change due to humidity | 85% RH |

As described above, the functional sprinkler for detecting microleakage occurring therein according to the present disclosure is configured to allow the hydrochromic paint to be applied to a coupled portion thereof and a welded area thereof, thereby efficiently checking whether water leakage exists through the corresponding construction and management company, reducing a maintenance cost, and avoiding safety accidents from occurring because there is no need to perform a facility manager's aerial work for checking the leakage.

Further, the functional sprinkler for detecting microleakage according to the present disclosure is configured to allow the deflector located on the end thereof to be changed in color at the time when the microleakage occurs, thereby directly checking an exact replacement time of the sprinkler with the naked eye of a manager and permitting a defect, corrosion due to aging, and content of wrong construction thereof to be detected directly with the naked eye of the manager.

Furthermore, the functional sprinkler for detecting microleakage according to the present disclosure is configured to allow the changed color due to the leakage to return to the original color, thereby being reusable.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above teachings. For example, the parts expressed in a singular form may be dispersedly provided, and in the same manner as above, the parts dispersed may be combined with each other.

It is therefore intended that the scope of the disclosure be limited not by this detailed description, but rather by the claims appended hereto. Thus, although the disclosure has been described with respect to specific embodiments, it will be appreciated that the disclosure is intended to cover all modifications and equivalents within the scope of the following claims.

What is claimed is:

1. A functional sprinkler for detecting microleakage occurring therein, comprising:
a frame;
a valve cap;
a glass bulb;
a deflector; and
a layer of a hydrochromic paint applied to a top or underside of the deflector,
wherein the layer of the hydrochromic paint changes a color of a portion in which the microleakage occurs.

2. The functional sprinkler according to claim 1, wherein the layer of the hydrochromic paint is formed to a thickness in the range between 10 and 50 μm by using any one selected from wet coating, dry coating, and spray coating.

3. The functional sprinkler according to claim 1, wherein the hydrochromic paint comprises:
3 to 10% by weight of a dye;
5 to 10% by weight of a pigment;
10 to 25% by weight of synthetic resins; and
a residual amount of solvents, based on 100% by weight thereof.

4. The functional sprinkler according to claim 1, wherein the hydrochromic paint contains 30 to 50% by weight of solid content, based on 100% by weight thereof.

5. The functional sprinkler according to claim 1, wherein the hydrochromic paint has a pH range between 4 to 7.

6. The functional sprinkler according to claim 3, wherein the dye is a pH indicator or redox indicator and is any one selected from bromophenol blue (BPB), bromocresol green (BCG), indigo carmine (IC), and cresol red (CR).

7. The functional sprinkler according to claim 3, wherein the pigment is an inorganic pigment and is any one selected from titanium dioxide, silicon dioxide, calcium carbonate, calcium oxide, calcium hydroxide, zeolite, activated carbon, bentonite, and aluminum silicate.

8. The functional sprinkler according to claim 3, wherein the synthetic resins are one or more materials selected from the group consisting of alkyd, acrylic polymer, polyester, phenol, melamine, urethane, silicone, and ester.

9. The functional sprinkler according to claim 3, wherein the additives are one or more materials selected from a curing accelerator, an adhesion promotor, a dispersant, and a mixture thereof.

10. The functional sprinkler according to claim 3, wherein the solvents are one or more materials selected from water, alcohol, ester, ketone, ether, and a mixture thereof.

11. A method for detecting microleakage in a sprinkler having a frame, a valve cap, a glass bulb, and a deflector, the method comprising the steps of:
coating a hydrochromic paint onto a top or underside of the deflector; and
if the microleakage occurs on a portion of the deflector where the hydrochromic paint is coated, detecting the microleakage through the change of the color of the hydrochromic paint coated onto the portion of the deflector where the microleakage occurs,
wherein the hydrochromic paint comprises a dye, a pigment, synthetic resins, additives, and solvents.

12. The method according to claim 11, further comprising the step of drying the hydrochromic paint through a heat treatment at a temperature between 12° and 180° C. for 10 to 30 minutes after the hydrochromic paint has been coated onto the top or underside of the deflector.

13. The method according to claim 11, wherein the hydrochromic paint is coated a plurality of times.
